(19) United States
(12) Patent Application Publication
(10) Pub. No.: US 2006/0168081 A1
(43) Pub. Date: Jul. 27, 2006

(54) Allocating communication bandwidth for executing Web applications

(76) Inventor: Akira Okada, Tokyo-to (JP)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/253,343

(22) Filed: Oct. 19, 2005

(30) Foreign Application Priority Data
Nov. 8, 2004 (JP) 2004-323768

(51) Int. Cl. G06F 15/16

(52) U.S. Cl. 709/207

(57) ABSTRACT

In a system for serving a remote office by Web applications provided by a server, higher communication bandwidth is dynamically allocated to applications that require rapid execution by utilizing idle bandwidth. The server may have a priority management table for managing priorities for data transmission, a user management table for managing the number of users of each Web application, and an application executing section for allocating bandwidth on the basis of the priorities and the number of users of each of the Web applications.

### BACKGROUND

The present invention relates to systems for controlling communication for the execution of Web applications, and more particularly relates to a system for controlling communication between a server and terminals with a plurality of active sessions.

At present, businesses typically rely on connecting a central system (hereinafter referred to as a center) and remote offices using a computer network. In the remote office, it is quite common for a terminal to access a central server via the network according to business requirements, and to either use a desired application or download or upload data from the server. Web-base networks like the Internet have become popular. As a result, applications used from the remote office are increasingly provided in the form of Web applications using, for example, Java (the registered trade mark of Sun Micro Systems in USA) servlets, and so on.

If each of the applications is used via a dedicated communication line, the bandwidth necessary for each application can be determined unambiguously. On the other hand, in cases where each of the applications is provided as a Web application, the bandwidth of the communication line must be shared when these applications are used at the same time.

Among a large number of businesses that access central servers from remote office terminals, some applications might be required to execute rapidly, whereas others might have less stringent requirements regarding processing times. Therefore, if bandwidth is divided equally to the applications under execution, operation might be inefficient in some situations.

For example, at the remote office, processing required to receive or to place an order should preferably be executed rapidly. On the other hand, there may often be a need for continuity when downloading data, but less of a need for immediacy. Therefore, if the processing to receive and place orders and the processing to download are run simultaneously, the former, i.e., receiving and placing orders, must be delayed while downloading data, despite the need for immediacy, thereby reducing operating efficiency.

A controlled method of allocating bandwidth on the basis of application types could be contrived to provide different priorities and bandwidths for different kinds of applications. Some such methods are discussed in Japanese Unexamined Patent Publication (Kokai) No. 2000-92123 and Japanese Unexamined Patent Publication (Kokai) No. 2003-16031.

As stated above, conventional technology provides for allocating bandwidth unequally depending on applications or users, instead of equally allocating the bandwidth to a plurality of sessions, in order to prevent a reduction in the operating efficiency in a remote-access system. In this method, however, the bandwidth allocated to each of the applications must be fixedly set. Consequently, there is no sharing of bandwidth even when a few applications are active and the rest are idle.

### SUMMARY

A server accepts access from a terminal via a network, and executes a Web application. According to aspects of the invention, the sever includes a priority management table for managing data transmission priorities of Web applications, a user management table for managing the number of users of each of the Web applications, and an application executing section for dynamically allocating bandwidth.

Bandwidth is allocated on the basis of the priorities stored in the priority management table and the number of users of each of the Web applications that are stored in the user management table when a plurality of Web applications that differ in their priorities are run simultaneously.

An application executing section controls allocation of bandwidth to the data transmission by inserting sleep periods within transmission bursts. The application executing section may allocate bandwidth to the data transmissions of an individual session of the Web applications responsive to session priority, so that bandwidth may be allocated in proportion to the priority of each of the Web applications.

### BRIEF DESCRIPTION OF THE DRAWINGS

The invention will be best understood by reading the detailed description that follows, together with the drawings, wherein:

FIG. 1 is a schematic view of a remote office system according to a preferred embodiment of the present invention;

FIG. 2 shows an exemplary hardware configuration of a computer apparatus preferable for use as a server in a preferred embodiment of the present invention;

FIG. 3 shows a functional configuration of the server;

FIG. 4 shows an exemplary configuration of a user identification table;

FIG. 5 shows an exemplary configuration for remote office management;

FIG. 6 shows an exemplary configuration of a user management table;

FIG. 7 shows an exemplary configuration of a priority management table;

FIG. 8 is a flow chart illustrating pre-processing;

FIG. 9 is a flow chart illustrating data transmission by the application executing section;

FIG. 10 illustrates a Java class as an exemplary support program;

FIG. 11 illustrates a Java class as an example of the communication control program; and

FIG. 12 is a flow chart illustrating the algorithm of the sleep-time method in the communication control program of FIG. 11.

### DETAILED DESCRIPTION

A description of a preferred embodiment of the present invention will now be provided with reference to the accompanying drawings.

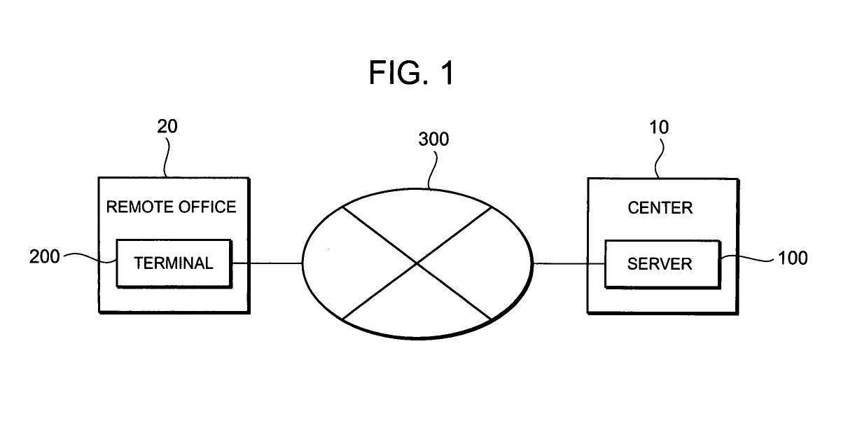

As illustrated in FIG. 1, a system comprises a center 10 and a remote office 20 connecting to the center 10. The center 10 is provided with a server 100, and the remote office 20 is provided with a terminal 200. The server 100 and the terminal 200 are connected through a computer network 300 such as the Internet or the like. Although a single remote office 20 is illustrated in FIG. 1, a plurality of remote offices 20 can be connected to a single center 10. Further, a plurality of centers 10 can be provided. Each remote office 20 can be provided with a plurality of terminals 200. A computer apparatus such as a personal computer or the like or an information apparatus having a networking function such as a PDA (Personal Digital Assistant) or the like can be used as the terminal 200

The server 100 at the center 10, in FIG. 1, is provided with a plurality of Web applications and databases. The use of functions provided by Web applications as well as download or upload of various data is possible by accessing the server 100 from the terminal 200 at the remote office 20. Priorities for data transmission are introduced regarding the Web applications provided in the server 100. Applications with high priority and applications with low priority are set. When high priority applications and low priority applications are executed at the same time, a dynamic control is performed to limit the usable bandwidth according the priority of each application, and data flow over a designated volume can be secured for the high priority applications. In the following description, when there is no necessity to distinguish a high priority application from a low priority application, either will be described simply as an application.

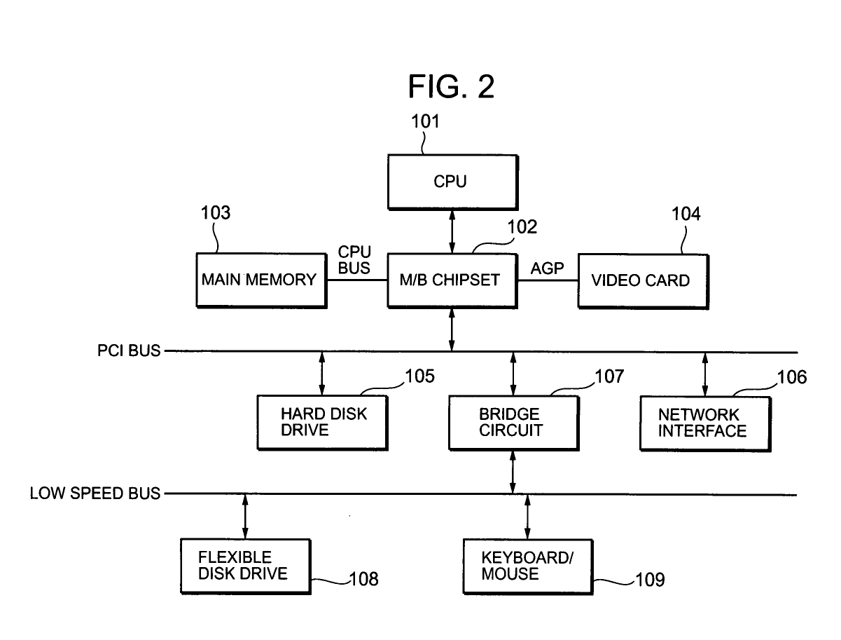

FIG. 2 illustrates an exemplary hardware configuration of apparatus suitable for constituting the server 100. The apparatus, which may be thought of as a computer but which is not so limited, is provided with a CPU (Central Processing Unit) 101 as a means of operation, a main memory 103 connected to the CPU 101 through a M/B (Mother Board) chipset 102 and a CPU bus, a video card 104 connected to the CPU 101 through also the M/B chipset 102 and an AGP (Accelerated Graphics Port), a hard disk drive (HDD) 105 connected to the M/B chipset 102 through a PCI (Peripheral Component Interconnect) bus, a network interface 106, a flexible disk drive 108, a keyboard or mouse 109 extended from the PCI bus and connected to the M/B chipset 102 through a bridge circuit 107, and a low speed bus such as an ISA (Industry Standard Architecture) bus, and so forth. FIG. 2 shows only an example of a suitable hardware configuration, however, and various other suitable configurations may be used as well.

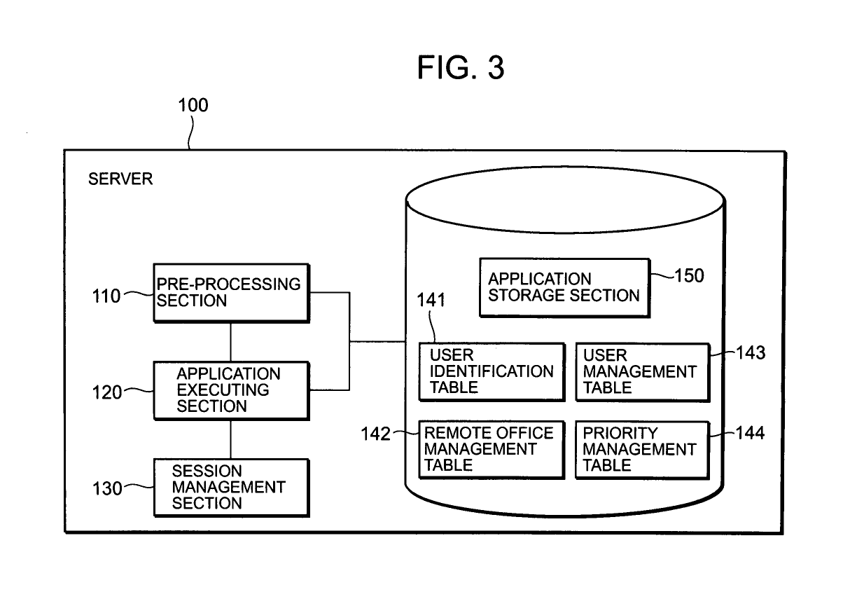

FIG. 3 illustrates a functional configuration of the server 100. The server 100 is provided with a pre-processing section 110 for executing pre-processing when an application is activated, an application executing section 120 for activating and executing the application pre-processed by the pre-processing section 110, a session management section 130 for managing sessions to use the application, and an application storage section 150 for storing applications. Further provided are a user identification table 141, a remote office management table 142, a user management table 143, and a priority management table 144, for storing necessary information to perform bandwidth control If the server 100 is realized, for example, with the apparatus illustrated in FIG. 2, these tables may be stored in a memory device such as the main memory 103, the magnetic disk device 105, and so forth.

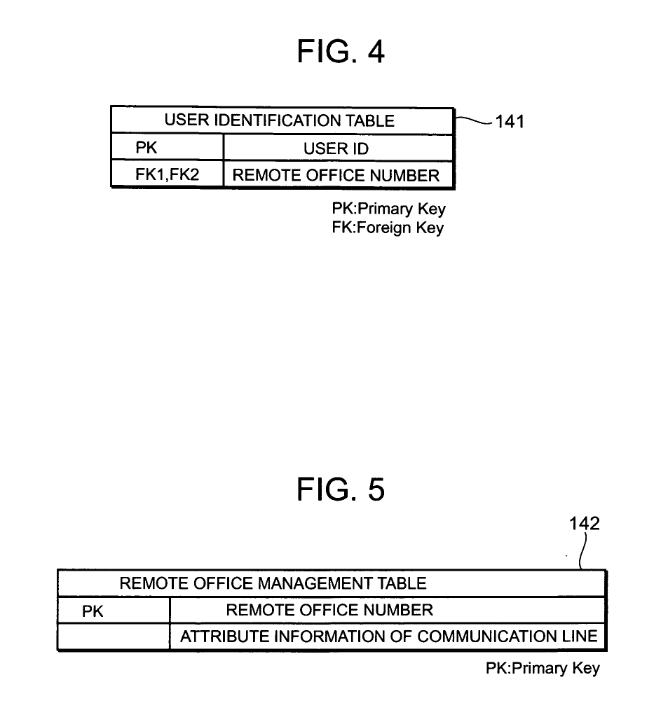

FIG. 4 illustrates an exemplary configuration of the user identification table 141. Information identifying the user (user ID) of the terminal 200 at the remote office 20 (member of the remote office 20), and information identifying the remote office 20 to which the user belongs (remote office number) are associated with each other in the user identification table 141. Each terminal 200 at the remote office 20 is connected to the server 100 at the center 10 via a common communication line.

FIG. 5 illustrates a configuration example of the remote office management table 142. The remote office number and the attribute information of the communication line (line type, line speed, bandwidth, and so on) between the remote office 20 and the center 10 are associated with each other in the remote office management table 142. While the user identification table 141 is for managing the user information in terms of a communication line, the remote office management table is for managing the attribute information. Bandwidth control is effective for the case wherein a plurality of applications use the same communication line. On the other hand, when different communication lines are used, there is no problem even if the control method of bandwidth is changed for each communication line. Therefore, it is feasible to apply a communication control suitable for each communication line, by managing the attribute of each communication line and referring to this information.

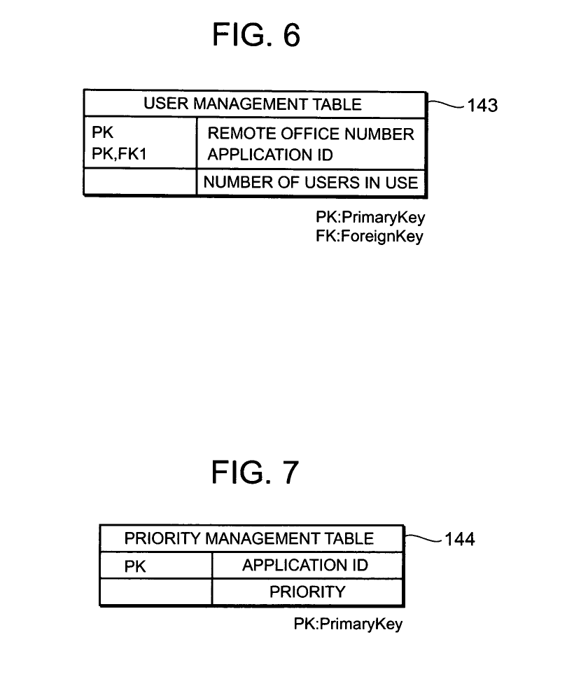

FIG. 6 illustrates an exemplary configuration of the user management table 143. The remote office number, the information identifying the application (application ID) used at the remote office identified by the remote office number, and the number of users currently executing sessions which use the application are associated with each other in the user management table 143.

FIG. 7 illustrates an exemplary configuration of the priority management table 144. The application ID and the priority level of the application (information indicating, for example, a distinction of whether it is a high priority application or a low priority application) are associated with each other in the priority management table 144.

By querying the user identification table 141, using as a key the user ID obtained at the time of authentication of an access requirement, the remote office 20 to which the relevant user belongs can be identified. By querying the remote office management table 142, using as a key the number of this remote office 20, the attribute information of the communication line used by the relevant remote office 20 can be obtained. Further, by querying the user management table 143, using as keys the remote office number and the application ID, the number of users of each remote office 20 currently using the relevant application can be found. By querying the priority management table 144, using as a key the application ID, whether this application is a high priority application or a low priority application can be determined.

The pre-processing section 110 may be realized by, for example, the program controlled CPU 101 in FIG. 2. This pre-processing section 110 receives an access requirement from a terminal 200 in an arbitrary remote office 20, and executes pre-processing for realizing the communication control. By means of this pre-processing, a program for supporting the communication control may be added to the application activated corresponding to the access requirement. The support program added to the application is described in detail below.

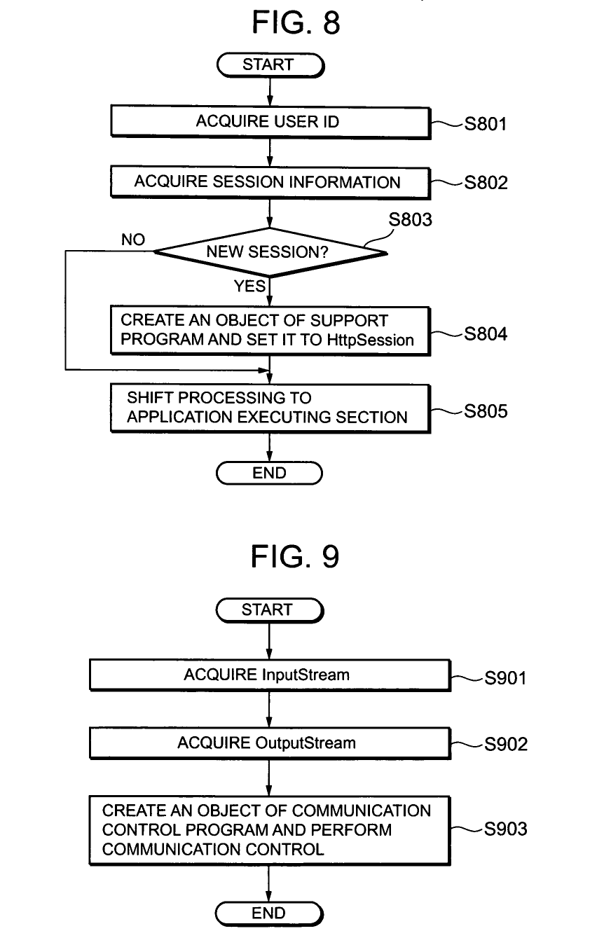

FIG. 8 illustrates pre-processing by the pre-processing section 110. For the purpose of clear description, it is assumed here that the application is a Java servlet, and the support program is added to the application as an object.

When the server 100 receives an access request from the terminal 200, it executes authentication processing of basic authentication, form base authentication, and so forth. If the access request is accepted as a result of the authentication, the pre-processing section 110 is started. The pre-processing section 110 obtains the user ID from the authentication process of the server 100 (Step 801). Then the pre-processing section 110 inquires and obtains the session information associated with the user ID from the session management section 130 (Step 802), and examines whether the access request is for starting a new session or for the session under execution (Step 803).

If the accepted access request is an access request to start a new session, the pre-processing section 110 creates an object of the support program, and sets the created object to the HttpSession of the application activated by this access request (Step 804). Then, the pre-processing section 110 passes the processing to the application executing section 120 (Step 805). On the other hand, in the case wherein the accepted access requirement is an access requirement to the session already being executed, the pre-processing section 110 passes the processing, without any pre-processing, to the application executing section 120 (Step 805).

The application executing section 120 may be realized by, for example, the program controlled CPU 101 in FIG. 2. The application executing section 120 activates the application program pre-processed by the pre-processing section 110, and starts a session for executing the application. When it executes the application, the program added by the pre-processing section 110 is also executed. Information concerning the session which is being executed is managed in the session management section 130. Further, the application executing section 120 executes the communication control when the data transmission is executed by the application. As described further below, the data flow in each application is adjusted by inserting sleep periods into transmission bursts. The data transmission by the application executing section 120 may be performed through, for example, the network interface 106 in FIG. 2.

FIG. 9 illustrates data transmission by the application executing section 120. It is assumed that the application is made as a Java Servlet. The application executing section 120 obtains an Input Stream (Step 901), and then obtains an Output Stream (Step 902). The application executing section 120 creates an object of the program for controlling the bandwidth (hereinafter referred to as communication control program) according to the priority of the application, and executes the communication control by this object until the end of the Input Stream obtained in Step 901 (Step 903).

The session management section 130 may be realized by, for example, the program controlled CPU 101 in FIG. 2. One function of this session management section 130 is the same as the session management function in the conventional Web application server, which is to acquire and manage the information regarding the session (the user ID of the user who executes the session, the application ID of the application used in the session, and so on) when a session object is created by the pre-processing section 110. This information is stored in a memory such as, for example, the main memory 103 in FIG. 2, and so forth, and is kept until the corresponding session is terminated.

The application storage section 150 may be realized by, for example, the magnetic disk device 105 in FIG. 2. Various kinds of applications used by the access from the terminal 200 may be stored. The priorities of the applications stored in the application storage section 150 are registered in the above-mentioned priority management table 144.

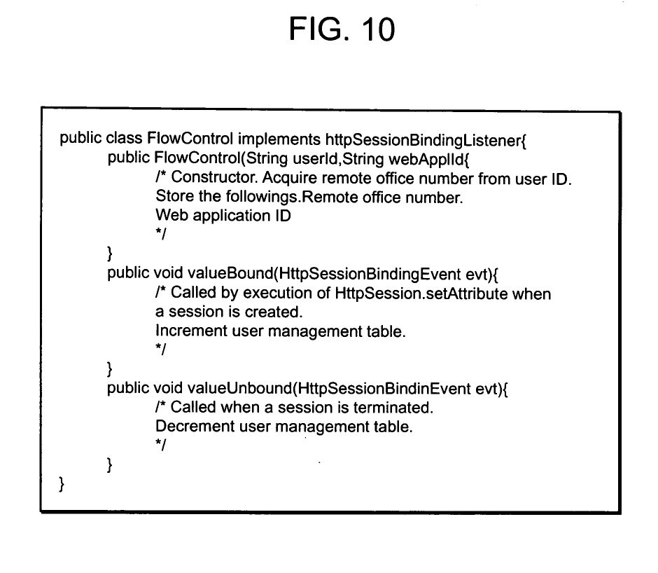

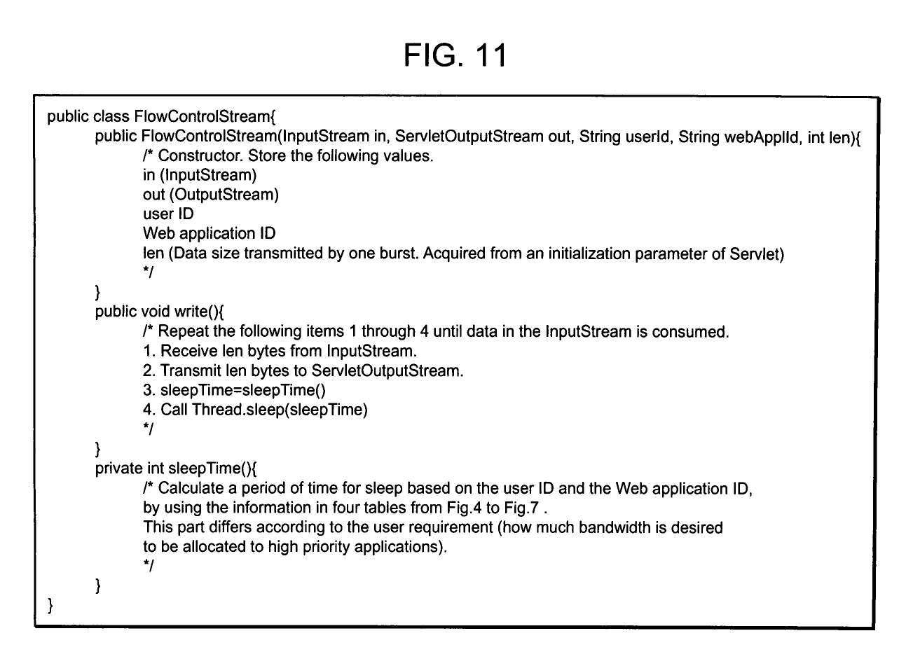

A description of the support program added to the application by the pre-processing section 110 is now provided. FIG. 10 illustrates a Java class as an example of the support program. In the constructor of the support program shown in FIG. 10, the user identification table 141 is queried using the user ID obtained in Step 801 in FIG. 8 as a key, and the remote office number of the remote office 20 to which the user belongs is acquired. The remote office number and the application ID for activating the application are stored.

The value Bound method and the value Unbound method are executed in the support program in FIG. 10. The value Bound method is called by the execution of the HttpSession.setAttribute when a session is created. The number of users in the user management table 143 corresponding to the remote office number and the application ID stored in the constructor is incremented by one. The value Unbound method, on the other hand, is called when the session is terminated. The number of users in the user management table 143 corresponding to the remote office number and the application ID stored in the constructor is decremented by one. The session can be intentionally invalidated by the request from the terminal 200, or it can time out if the terminal 200 does not access the application over a certain period of time. The valueUnbound method is executed in either case.

A description of the communication control program executed by the application executing section 120 is now provided. FIG. 11 illustrates a Java class as an example of the communication control program. In the constructor of the communication control program shown in FIG. 11, a value of InputStream, a value of OutputStream, the user ID, the application ID, and len (the data size to transmit in one burst) are acquired and stored. Here, the value of len is acquired from the initialization parameter of the application.

In the communication control program in FIG. 11, the write method is executed, and within it the sleep time method is further executed. In the write method, data having a size of len is received from the InputStream in every burst, and it is transmitted to the OutputStream. Between bursts, the sleep time method is called and the data transmission goes into sleep status for the time determined by the sleep time method.

A more detailed description of the sleep time method is now provided. As stated above, the write method of the communication control program (FlowControlStream class) shown in FIG. 11 transmits data having a size of len kilo bytes at a time as a burst to the Output Stream. Between bursts, the data transmission goes into sleep status for the time (in seconds) determined by the sleep time method. Therefore, the effective data transmission band is expressed by
len*8/sleepTime (Kbps).
Based on this formula, the algorithm of the sleep time method may be determined as follows.

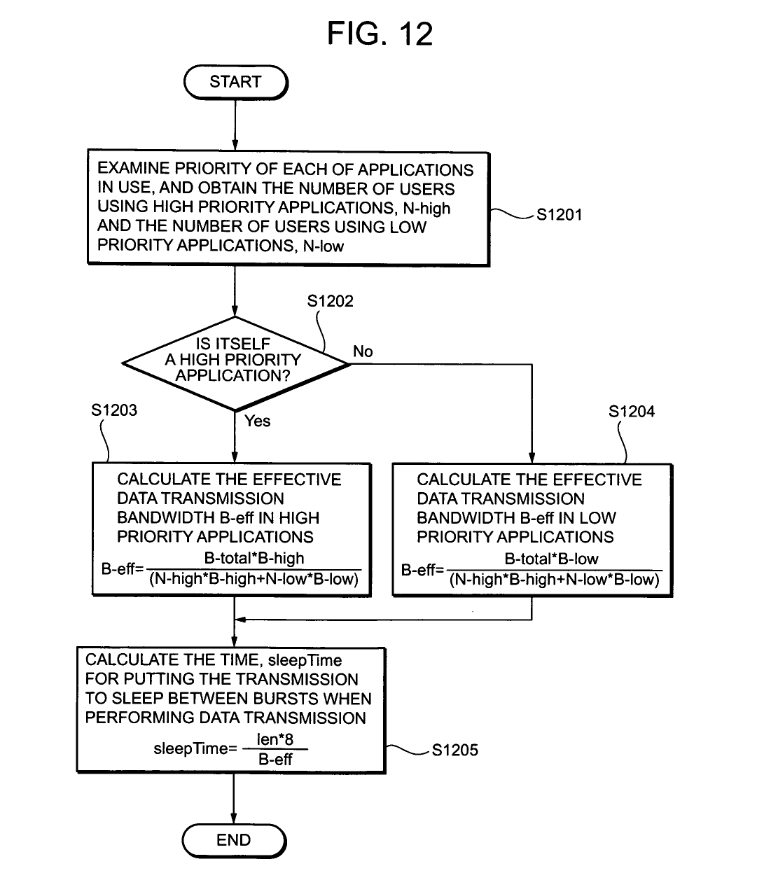

FIG. 12 is a flow chart illustrating the algorithm of the sleep time method. As referred to FIG. 12, in the sleep time method, the user identification table 141 is entered using as a key the user ID stored by the constructor of the communication control program shown in FIG. 11, and the remote office number of the remote office 20 to which the user belongs is acquired. Then, the user management table 143 is entered using as a key the acquired remote office number, and it is examined to determine which application is used by how many users respectively in the same remote office 20. Further, the priority management table 144 is entered using as a key the application IDs of the applications now in use acquired during this processing, and whether each application currently being used is a high priority application or a low priority application is determined. Based on this information, the number of users using high priority applications, N-high, and the number of users using low priority applications, N-low, are obtained regarding the applications currently being used (Step 1201).

The priority is determined of the application in which this sleep time method is being executed (Step 1202). If this is determined to be a high priority application, the effective data transmission band B-eff in this high priority application is calculated by the expression 1, which follows (Step 1203):

$$B - eff = \frac{B - total * B - high}{( N - high * B - high + N - low * B - low )}$$

On the other hand, if the application in which the sleep time method is being executed is determined to be a low priority application, the effective data transmission band B-eff is calculated by the expression 2, which follows (Step 1204):

$$B - eff = \frac{B - total * B - low}{( N - high * B - high + N - low * B - low )}$$

Using the data transmission band B-eff calculated as the above, the sleep time to be kept sleeping between bursts during data transmission is calculated by the expression 3, which follows (Step 1205):

$$sleepTime = \frac{len * 8}{B - eff}$$

For example, assume that the bandwidth of the communication line B-total is 1000 Kbps, and the ratio is four to one for the degree of the bandwidth utilization given to the users of the high priority applications B-high and the degree of the bandwidth utilization given to the users of the low priority applications B-low. Assume also that a high priority application and a low priority application are both executed by two users (that is, two sessions are allocated in each application). As a specific mode of sessions, it may be assumed that there are a single high priority application and a single low priority application, and two sessions are running for each of them. Alternatively, it may be assumed that there are a plurality of high priority applications and a plurality of low priority applications, and a session is running for each of the two high priority applications and the two low priority applications, respectively.

In this example, the bandwidth allocated to the users of the high priority application is 400 Kbps (=1000 Kbps*4/(2*4+2*1)), and the bandwidth allocated to the users of the low priority application is 100 Kbps (=10000 Kbps*1/(2*4+2*1)).

As described above, in the case wherein the high priority application and the low priority application are executed at the same time, and the communication line is used by these operations at the same time, the operation of the high priority application is given broader bandwidth according to the predetermined ratio. On the other hand, in the case wherein only one of either the high priority application or the low priority application is executed, the number of the users using the other application (N-low or N-high) becomes zero. Therefore, the value obtained by dividing the total bandwidth B-total by the number of the users of the application in use is equally allocated to each operation. In this way, it becomes possible to dynamically control the bandwidth allocated to each application according to whether or not different priority applications are used at the same time. Since the high priority applications are given broader bandwidth when different priority applications are used at the same time, decreased operating efficiency due to a delay of the operation using high priority applications can be prevented.

In the foregoing example, the proportion of the bandwidth allocated to an individual user (session) of the high priority application and the bandwidth allocated to an individual user (session) of the low priority application is defined beforehand, and the bandwidth is allocated to the users of each application according to the defined proportion. That is, regardless of how many users are using the high priority application and how many users are using the low priority application, the proportion of the bandwidth allocated to an individual user of the high priority application and the bandwidth allocated to an individual user of the low priority application is the same (the value defined beforehand, which is four-to-one in the above example).

On the other hand, the proportion of the bandwidth allocated to each application may also be set for the case wherein the high priority application and the low priority application are used at the same time. When there are a plurality of users of the high priority application and the low priority application, the bandwidth is allocated to each user by dividing the bandwidth allocated to each application by the number of users. For example, assume that the bandwidth of the communication line is 1000 Kbps, the proportion of the bandwidth allocated to each application is four to one, the number of the users of the high priority application is one, and the number of the users of the low priority application is two. In this case, 800 Kbps (=1000 Kbps*4/(4+1)) is allocated to the high priority application, and 200 Kbps (=1000 Kbps*1/(4+1)) is allocated to the low priority application. Because the number of the users of the high priority application is one, 800 Kbps is allocated to this user as a result. Because the number of the users of the low priority application is two, 100 Kbps (=200 Kbps/2) is allocated to each of these users as a result. In this way, when the proportion of the bandwidth allocated to each application is predetermined according to the priority level, the proportion of the bandwidth allocated to an individual user of the high priority application and the bandwidth allocated to an individual user of the low priority application vary depending on the number of the users of each application.

There may also be a case wherein, according to the system mode or the usage environment, for example, no more than one of each of the high priority application and the low priority application is executed respectively, at a point in time, in the same remote office. In this case, it is possible to allocate the broad bandwidth preferentially to the high priority applications, by controlling only the bandwidth used by the low priority applications when the high priority applications are being used, without determining the proportion of the bandwidth utilization of the high priority applications and the low priority applications.

With this kind of control, a bandwidth usable for the low priority applications when it used concurrently with the high priority applications is predetermined, and the sleep time to realize such a bandwidth for data transmission is calculated beforehand. In the sleep time method, the user management table 143 is entered to judge whether or not the number of users of the high priority applications is one, and if the number of the users of the high priority applications is one, the preliminarily calculated sleep time sleep time is returned to the write method.

If the bandwidth has sufficient margin, a simple control like this is feasible even in a system wherein operations by the high priority applications and operations by the low priority applications are executed simultaneously. In this case, if a bandwidth usable for two low priority applications when run simultaneously with high priority applications is assumed to be 100 Kbps, 200 Kbps (=100 Kbps*2) is used for the low priority applications, and the bandwidth usable for the high priority applications is limited accordingly. However, if the total bandwidth is sufficient, the difference is small even if the total bandwidth used by the low priority applications is increased according to the number of the users, and the effect on the operation of the high priority applications is also small.

Although the applications have been classified into two categories in the foregoing description, which are high priority applications and low priority applications, it is also feasible to have more than two priority levels so as to dynamically control the bandwidth. In this case, the bandwidth utilization degree is set as well to the respective priority levels of applications. In the sleep time method, the effective data transmission bandwidth in the applications of each priority level is calculated by extending the above-mentioned Expressions 1 and 2 to obtain the sleep time.

Furthermore, in addition to the high priority applications and low priority applications mentioned so far, applications that do not belong to either class may be included as well. For example, a Web application may infrequently use the communication line because only local processing is normally executed. Such an application affects the communications of the other applications very little. Therefore, such an application may coexist with the high and low priority applications as a Web application belonging to neither the set of high priority applications nor the set of low priority applications.

In addition, by registering an attribute of the users in the user identification table 141, attribute information can be combined with the communication control. As the user attribute, for example, the rank (president, manager, and the like) or the profession (marketing, service, and the like) can be registered, and used to set priorities.

We claim:

1. A server for accepting access from a terminal via a network and executing Web applications, comprising:
a priority management table for managing data transmission priorities for Web applications;
a user management table for managing the number of users for each of the Web applications; and
an application executing section for dynamically allocating bandwidth to data transmission for the use of at least one of the Web applications when a plurality of the Web applications having priorities that are different from one another are used simultaneously, wherein bandwidth is dynamically allocated based on priorities stored in the priority management table and numbers of users of Web applications stored in the user management table.

2. The server according to claim 1, wherein the application executing section controls allocation of bandwidth by inserting sleep times in transmission bursts.

3. The server according to claim 1, wherein the application executing section allocates bandwidth to individual sessions that use the Web applications in proportion to the respective priorities of the Web applications.

4. The server according to claim 1, wherein the application executing section allocates bandwidth to each set of Web applications of a plurality of sets of Web applications in proportion to the priority of each set of Web applications, and determines a bandwidth allocated to an individual session of a particular set of Web applications by dividing the bandwidth allocated to the particular set of Web applications by the number of users of the particular set of Web application.

5. A server for accepting access from a terminal via a network and executing Web applications, comprising:
a priority management table for managing data transmission priorities for the Web applications; and
an application executing section for dynamically allocating bandwidth to data transmission for use by at least one of the Web applications when a plurality of the Web applications having priorities that are different from one another are used simultaneously, wherein bandwidth is dynamically allocated based on priorities stored in the priority management table.

6. The server according to claim 5, wherein the application executing section controls allocation of bandwidth by inserting sleep periods in transmission bursts.

7. The server according to claim 5, wherein the application executing section allocates bandwidth to individual sessions that use the Web applications in proportion to the respective priorities of the Web applications.

8. The server according to claim 5, wherein the application executing section allocates bandwidth to each set of Web applications of a plurality of sets of Web applications in proportion to the priority of each set of Web applications.

9. A method of executing Web applications by a server, comprising:
determining the number of users of each of a plurality of Web applications; and
controlling allocation of bandwidth to data transmission sessions of the Web applications by inserting sleep periods into transmission bursts for at least one Web application when more than one Web application is in use.

10. The method according to claim 9, further comprising:
maintaining a user table that tracks active sessions; and
referring to the user table when determining the number of users of each of a plurality of Web applications.

11. The method according to claim 9, wherein, in controlling allocation of bandwidth, bandwidth is allocated to an individual session of each of the Web applications according to a predetermined proportion based on a priority.

12. The method according to claim 9, wherein, in controlling allocation of bandwidth, bandwidth is dynamically allocated to data transmission for use by at least one of the Web applications when a plurality of the Web applications having priorities that are different from one another are used simultaneously, wherein bandwidth is dynamically allocated based on the priorities.
